(19) United States
(12) Patent Application Publication
(10) Pub. No.: US 2019/0347600 A1
(43) Pub. Date: Nov. 14, 2019

(54) COMPUTER-ASSISTED INTERVIEW METHOD AND DEVICE BASED ON ARTIFICIAL INTELLIGENCE, AND STORAGE MEDIUM

(71) Applicant: BAIDU ONLINE NETWORK TECHNOLOGY (BEIJING) CO., LTD., Beijing (CN)

(72) Inventors: Dazhong SHEN, Beijing (CN); Hengshu ZHU, Beijing (CN); Chao MA, Beijing (CN); Chen ZHU, Beijing (CN); Hui XIONG, Beijing (CN)

(21) Appl. No.: 16/406,893

(22) Filed: May 8, 2019

(30) Foreign Application Priority Data
May 10, 2018 (CN) 201810443339.7

(51) Int. Cl. G06Q 10/06; G06K 9/62; G06Q 10/10

(52) U.S. Cl. CPC G06Q 10/063112; G06Q 10/1053; G06K 9/6256; G06K 9/6215

(57) ABSTRACT

The present disclosure provides a computer-assisted interview method and a computer-assisted interview device. The method includes: receiving description information of a job; receiving description information of each of a plurality of applicants; based on a pre-trained assisted interview model, determining a first parameter distribution corresponding to the description information of the job and determining a second parameter distribution corresponding to the description information of each of the plurality of applicants; determining a matching degree between the job and each of the plurality of applicants based on the first parameter distribution and the second parameter distribution; and filtering out an applicant corresponding to a matching degree meeting a first preset condition as a target applicant.

### CROSS REFERENCE TO RELATED APPLICATION

This application claims priority to Chinese Patent Application No. 201810443339.7 filed on May 10, 2018.

### FIELD

The present disclosure relates to the field of computer technologies, and more particularly to a computer-assisted interview method and a computer-assisted interview device based on artificial intelligence, and a storage medium.

### BACKGROUND

In the era of knowledge-based economy, personnel recruitment has become an important factor affecting the development of an enterprise. In conventional personnel recruitment, an interviewer talks with an applicant face to face, to assess the applicant's ability such as professional technique and comprehensive ability, and to decide the final interview result.

In this way, the interview result relies on personal experience and preference of the interviewer, and it also relies on data that may be obtained in the interviewer's acknowledge field, which lack support of objective data, potentially resulting in poor interview outcome.

### SUMMARY

A computer-assisted interview method based on artificial intelligence provided in a first aspect of embodiments of the present disclosure includes: receiving description information of a job; receiving description information of each of a plurality of applicants; based on a pre-trained assisted interview model, determining a first parameter distribution corresponding to the description information of the job and determining a second parameter distribution corresponding to the description information of each of the plurality of applicants, in which, the first parameter distribution is configured to indicate a distribution of one or more topics referred by the description information of the job, and the second parameter distribution is configured to indicate a distribution of one or more topics referred by the description information of the corresponding applicant; determining a matching degree between the job and each of the plurality of applicants based on the first parameter distribution and the second parameter distribution; and filtering out an applicant corresponding to a matching degree meeting a first preset condition as a target applicant.

A second aspect of embodiments of the present disclosure provides an electronic device including: one or more processors; a memory; one or more programs, stored in the memory, when being executed by the one or more processors, configured to perform the above computer-assisted interview method based on artificial intelligence.

A third aspect of embodiments of the present disclosure provides a non-temporary computer readable storage medium. When instructions in the storage medium are executed by a processor of a mobile terminal, the mobile terminal executes the above computer-assisted interview method based on artificial intelligence.

Additional aspects and advantages of embodiments of the present disclosure will be given in part in the following descriptions, and become apparent in part from the following descriptions, or be learned from the practice of the embodiments of the present disclosure.

### BRIEF DESCRIPTION OF THE DRAWINGS

These above and additional aspects and advantages of embodiments of the present disclosure will become apparent and more readily appreciated from the following descriptions made with reference to the drawings, in which:

FIG. 1 is a flow chart illustrating a computer-assisted interview method based on artificial intelligence according to an embodiment of the present disclosure;

FIG. 2 is a flow chart illustrating a computer-assisted interview method based on artificial intelligence according to an embodiment of the present disclosure;

FIG. 3 is a flow chart illustrating a computer-assisted interview method based on artificial intelligence according to an embodiment of the present disclosure;

FIG. 4 is a schematic diagram illustrating a target model in embodiments of the present disclosure.

FIG. 5 is a block diagram illustrating a computer-assisted interview device based on artificial intelligence according to an embodiment of the present disclosure; and

FIG. 6 is a block diagram illustrating a computer-assisted interview device based on artificial intelligence according to an embodiment of the present disclosure.

### DETAILED DESCRIPTION

Description will be made in detail below to embodiments of the present disclosure. Examples of embodiments are illustrated in the accompanying drawings, in which, the same or similar numbers represent the same or similar elements or elements with the same or similar functions. Embodiments described below with reference to the accompanying drawings are exemplary, which are intended to explain the present disclosure and do not be understood a limitation of the present disclosure. Instead, the embodiments of the present disclosure comprise all the variants, modifications and their equivalents within the spirit and scope of the present disclosure as defined by the claims.

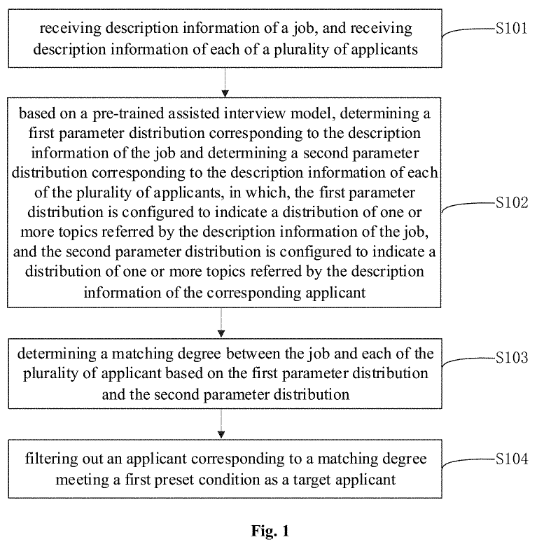

FIG. 1 is a flow chart illustrating a computer-assisted interview method based on artificial intelligence according to an embodiment of the present disclosure.

The example is that the computer-assisted interview method based on artificial intelligence is configured in a computer-assisted interview device based on artificial intelligence.

In this embodiment, the computer-assisted interview method based on artificial intelligence may be configured in the computer-assisted interview device based on artificial intelligence, and the computer-assisted interview device based on artificial intelligence may be provided in a server, or in an electronic device, which is not limited in embodiments of the present disclosure.

Another example is that the computer-assisted interview method based on artificial intelligence is configured in the electronic device in this embodiment.

The electronic device is a hardware device having various operation systems such as a smart phone, a table computer, a personal digit assistant and an electronic book.

It should be noted that, an executive subject of embodiments of the present disclosure, in hardware, may be such as the server or a CPU (Central Processing Unit) in the electronic device, and, in software, may be such as the server or related background services in the electronic device, which is not limited.

In the era of knowledge economy, personnel recruitment has become an important factor affecting a development of an enterprise. In conventional personnel recruitment, an interviewer talks with an applicant face to face, to investigate the applicant' ability such as a professional technique and a comprehensive ability, and to decide a final interview result.

In this way, the interview result relies on personal experience and preference of the interviewer, and further relies on data that may be obtained in the interviewer's acknowledge field, which lack a support of objective data, potentially resulting in poor interview effect. To solve the above problems, with the computer-assisted interview method based on artificial intelligence, the applicant is filtered out as the target application to assist the interview according to the matching degree between the job and each of the plurality of applicants, and the matching degree is obtained based on the pre-trained assisted interview model. Therefore, it may assist the interviewer to interview in conjunction with artificial intelligent technologies, thereby providing a support of objective data, and improving the interview effect.

Referring to FIG. 1, the method includes acts in the following blocks.

At block S101, description information of a job is received, and description information of each of a plurality of applicants is received.

The job may be such as a human resource job, a technical job, a managerial job.

The description information of the job is such as detailed recruitment requirements corresponding to the job. The description information of the job may be presented in form of text.

The description information of each of the plurality of applicants is content such as a self-introduction, a work experience and a project experience in a corresponding resume.

The description information of each of the plurality of applicants may be presented in form of text.

In a detailed executing procedure of embodiments of the present disclosure, an input interface may be provided in the electronic device, to receive the description information of the job and the description information of each of the plurality of applicants, input by a user.

It should be understood that, in an actual interview scene, one or more resumes of one or more applicants may be received for one job. In embodiments of the present disclosure, to improve the interview efficiency, a data mining technology in the related art may be employed first, to extract data from the received resume of each of the plurality of applicants, thereby obtaining the description information of each of the plurality of the applicants, and to further extract the description information of the job from the recruitment website interface. Or the description information of the job and the description information of each of the plurality of applicants, input by the user, are directly received, which is not limited.

At block S102, based on the pre-trained assisted interview model, a first parameter distribution corresponding to the description information of the job is determined and a second parameter distribution corresponding to the description information of each of the plurality of applicants is determined, in which, the first parameter distribution is configured to indicate a distribution of one or more topics referred by the description information of the job, and the second parameter distribution is configured to indicate a distribution of one or more topics referred by the description information of the corresponding applicant.

The assisted interview model is obtained by training based on interview data related to historical interview records in advance. By way of example, the interview data may be text data recorded during interview. The text data may be collected from Baidu Talent Think Tank Project Database (which is database provided by Baidu company).

The text data, in the historical interview records, may be, for example, request description of each job, resume information of each of the plurality of applicants, an interviewer's interview comment for each applicant, and a job category of all the interviewers joining to each interview (such as, a technical category interviewer, a comprehensive category interviewer).

A training method for the assisted interview model may refer following embodiments.

In embodiments of the present disclosure, to combine actually obtained various description information with the assisted interview model obtained by training based on artificial intelligence, based on the pre-trained assisted interview model, a parameter distribution corresponding to the description information of the job may be determined, in which, the parameter distribution may be called as the first parameter distribution, and a parameter distribution corresponding to the description information of each of the plurality of applicants may be determined, in which, the parameter distribution may be called as the second parameter distribution. The description information of each of the plurality of applicants may correspond to one second parameter distribution.

The first parameter distribution is configured to indicate the distribution of one or more topics referred by the description information of the job. The second parameter distribution is configured to indicate the distribution of one or more topics referred by the description information of the corresponding applicant.

The first parameter distribution and the second parameter distribution may be represented in form of parameters.

In the present disclosure, a word distribution corresponding to the description information in form of text may be determined first, and then a topic distribution is derived according to the corresponding word distribution by employing a continuous multivariate probability distribution (such as, Dirichlet distribution), which is not limited.

Or, the word distribution corresponding to the description information may also be taken as an input of the pre-trained assisted interview model, to obtain the parameter distribution corresponding to the description information.

For example, with the description information J_{new} of a new job (description information R_{new} of the applicant), by setting other types of text data (the description information and the interview comment of the resume/the description information and the interview comment of the job) in the pre-trained assisted interview model to null, the topic distribution θJ_{new} of the description information J_{new} of the job and the topic distribution θ^{R}_{new} of the description information R_{new} of the applicant may be obtained by using the pre-trained assisted interview model.

At block 5103, a matching degree between the job and each of the plurality of applicants is determined based on the first parameter distribution and the second parameter distribution.

An example for determining the matching degree between the job and each of the plurality of applicants in the above act may be as follows.

When the matching degree between the job and each of the plurality of applicants is determined based on the first parameter distribution and the second parameter distribution, a similarity (such as a cosine similarity or a relative entropy) between θJ_{new} and θ^{R}_{new} may be taken as a measure of the marching degree between the description information J_{new} of the job and the description information R_{new} of the applicant, and the measure is taken as the marching degree between the job and each of the plurality of applicants.

In the detailed executing procedure of embodiments of the present disclosure, since the number of dimensions of θ^{J}_{new} may be different from that of θ^{R}_{new}, \tilde{θ}^{J}_{new} may be obtained by using the formula of

$${\tilde{θ}}_{new , k}^{R} = {\sum }_{c ∈ {C}_{k}} {θ}_{new , c}^{R} ,$$

to replace θ^{R}_{new}, in which Cₖ is a set of components generated by θJ_{new,k} in all components of θ^{R}_{new}. As another aspect, the two representation vectors θ^{J}_{new} and θ^{R}_{new} are spliced as a feature input to train a classifier (such as, a random forest classifier), and a predicted probability value obtained after training the classifier may also be taken as the matching degree between the job and each of the plurality of the applicants.

At block S104, an applicant corresponding to a matching degree meeting a first preset condition is filtered out as a target applicant.

The target applicant is an applicant having a higher matching degree with the current job.

The target applicant is filtered out from the plurality of applicants based on the matching degree, and the information of the applicant having the higher matching degree is provided to the interviewer as a reference, to enable the interviewer to fast determine a suitable candidate, thereby effectively improving the interview effect.

In this embodiment, to technically implement filtering out the target applicant from the plurality of applicants, a first preset condition is also provided. The first preset condition may be preset by the user according to the actual interview scene, or may also be preset by a factory program of the electronic device. The first preset condition may specifically be a data range or a numerical threshold.

After the above acts, the matching degree between the job and each of the plurality of applicants is determined, each matching degree may be matched with the first preset condition, and an applicant corresponding to the matching degree matched is taken as the target applicant.

In this embodiment, the applicant is filtered out as the target applicant to assist the interview according to the matching degree between the job and each of the plurality of applicants, and the matching degree is obtained based on the pre-trained assisted interview model. Therefore, it may assist the interviewer to interview in conjunction with artificial intelligent technologies, thereby providing a support of objective data, and improving the interview effect.

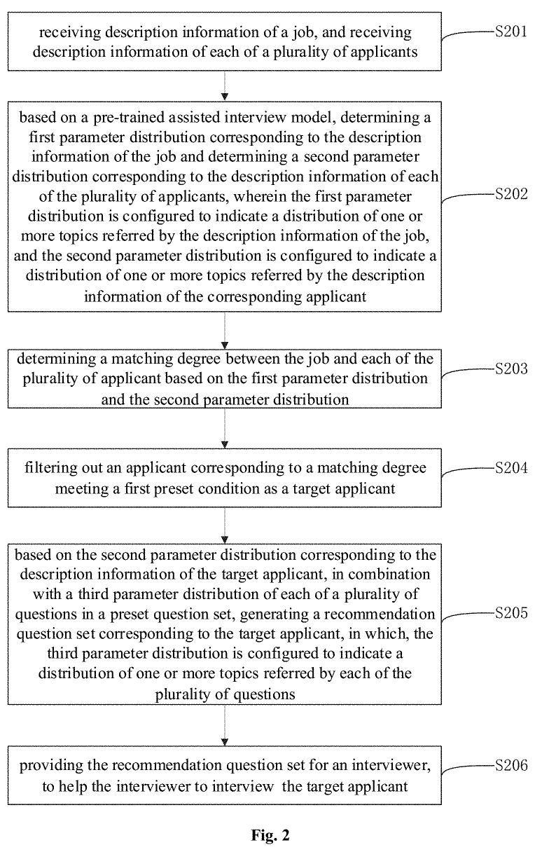

FIG. 2 is a flow chart illustrating a computer-assisted interview method based on artificial intelligence according to an embodiment of the present disclosure.

Referring to FIG. 2, the method includes acts in the following blocks.

At block S201, description information of a job is received, and description information of each of a plurality of applicants is received.

At block S202, based on a pre-trained assisted interview model, a first parameter distribution corresponding to the description information of the job is determined, and a second parameter distribution corresponding to the description information of each of the plurality of applicants is determined, in which, the first parameter distribution is configured to indicate a distribution of one or more topics referred by the description information of the job, and the second parameter distribution is configured to indicate a distribution of one or more topics referred by the description information of the corresponding applicant.

At block S203, a matching degree between the job and each of the plurality of applicants is determined based on the first parameter distribution and the second parameter distribution

At block S204, an applicant corresponding to a matching degree meeting a first preset condition is filtered out as a target applicant.

At block S205, based on the second parameter distribution corresponding to the description information of the target applicant, in combination with a third parameter distribution of each of a plurality of questions in a preset question set, a recommendation question set corresponding to the target applicant is generated, in which, the third parameter distribution is configured to indicate a distribution of one or more topics referred by each of the plurality of questions.

The preset question set may include a plurality of questions. The plurality of questions may provide a reference for the interviewer, to ask the applicant.

The preset question set may be generated in advance. In detail, the preset question set may be generated by learning and searching massive interview questions in Internet.

The interview result depends on the data that may be obtained in the interviewer's acknowledge field in the related art, which lacks the support of objective data. However, with embodiments of the present disclosure, by configuring the preset question set and performing model analysis on the distribution of one or more topics referred by the description information of the corresponding applicant and the distribution of one or more topics referred by each question in the preset question set, the related degree between each question and the target applicant may be obtained.

In embodiments, based on the second parameter distribution corresponding to the description information of the target applicant, in combination with the third parameter distribution of each of the plurality of questions, the target function is trained; the training result obtained by training each target function is obtained to obtain the training result corresponding to each target function; a question corresponding to a training result meeting a second preset condition is filtered out; and the recommendation set corresponding to each target applicant is generated according to filtered questions.

As an example, in this embodiment, a preset question set Q={qᵢ}ᵢ₌₁^{N} may be collected from excellent interview comments in the historical interview records. In this embodiment, a suitable question sub-set X with a fixed size may be filtered out from the preset question set, in which, X⊂Q. |X|=L is taken as the recommendation set, to recommend for the interviewer. By regarding each question qᵢ in the preset question set as a part of interview comments, and using the pre-trained assisted interview model in the above block S102, the third parameter distribution θᵢ^{Q} corresponding to the question is determined. For the above block S102, the topic distribution θ_{new}^{γ} (the first parameter distribution or the second parameter distribution) may be obtained for the description information of a job or the description information of an applicant. After obtaining the above data, in this embodiment, to recommend a recommendation question set with a high quality, following aspects should be satisfied. A first aspect, the recommended question should be related to γ. The other aspect, there may be some diversities between problems, thus needing to take into account the similarity and diversity of the recommendation problem set. Embodiments of the present disclosure may train the following target function, and a training target is configured to enable the output value of the target function to be maximum. The target function is

$$F ( γ , X ) = μ \frac{Sim ( γ , X )}{\overline{Sim}} + ( 1 - μ ) \frac{Div ( X )}{\overline{Div}} = μ \frac{{\sum }_{{q}_{i} ∈ X} Cosine ( {θ}_{new}^{γ} , {θ}_{i}^{Q} )}{\overline{Sim}} + ( 1 - μ ) \frac{{\sum }_{{q}_{i} ∈ X} {\sum }_{{q}_{j} ∈ X} 1 - Cosine ( {q}_{i} , {q}_{j} )}{\overline{Div}} ;$$

in which, S̅i̅m̅ and D̅i̅v̅ are regularization terms, and 0<μ<1.

The training target enabling the output value of the target function to be maximum may be called as a second preset condition.

At block S206, the recommendation question set is provided for the interviewer, to help the interviewer to interview the target applicant.

In embodiments, the applicant is filtered out as the target applicant to assist the interview according to the matching degree between the job and each of the plurality of applicants, and the matching degree is obtained based on the pre-trained assisted interview model. Therefore, it may assist the interviewer to interview in conjunction with artificial intelligent technologies, thereby providing a support of objective data, and improving the interview effect.

In this embodiment of the present disclosure, the question corresponding to the third parameter distribution enabling the output value of the above target function maximum may be filtered out, and the recommendation question set corresponding to each of the plurality of target applicants is generated according to the corresponding filtered questions, to implement to generate a targeted recommendation problem set for each of the plurality of target applicants and enable the interview questions for each of the plurality of target applicants more targeted, thus improving the interview effect. In addition, the present disclosure may also provide an intelligent assisted suggestion for the interviewer based on the matching degree between the job and each of the plurality of applicants and the generated recommendation question set, which may effectively reduce work burden of the interviewer and improve the effectiveness of the interview flow. And, the present disclosure uses a machine to replace part of work (such as, performing a measure on the matching degree between the job and each of the plurality of applicants, constructing the recommendation set) of the interviewer, thus saving the company's human resources and reducing the interview cost.

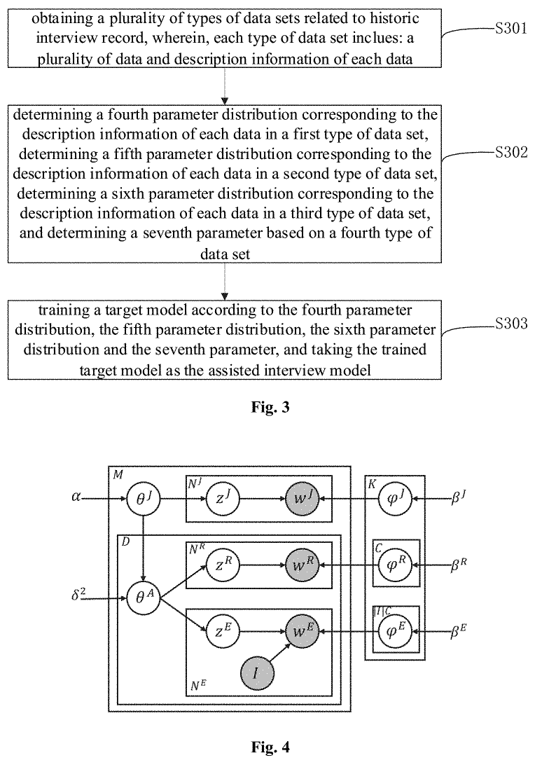

FIG. 3 is a flow chart illustrating a computer-assisted interview method based on artificial intelligence according to an embodiment of the present disclosure.

This embodiment illustrated in FIG. 3 is to explain the training procedure of the above assisted interview model.

Referring to FIG. 3, the method includes acts in the following blocks.

At block S301, a plurality of types of data sets related to historic interview record is obtained, in which, each type of data set includes: a plurality of data and description information of each data.

The assisted interview model is obtained by training based on the interview data related to the historical interview records. The interview data may be, for example, text data recorded during the interview. The text data may be collected from Baidu Talent Think Tank Project Database.

The text data, in the historical interview record, may be, for example, a request description of each job, resume information of each of the plurality of applicants, an interviewer's interview comment for each applicant, and a job category of all the interviewers joining to each interview (such as, a technical category interviewer, a comprehensive category interviewer).

Alternatively, a plurality of types of data sets includes: a job data set, an applicant data set, an interview comment set and an interviewer information set.

The job data set includes: a plurality of jobs and description information of each of the plurality of jobs.

The applicant data set includes: a plurality of markers and description information of an applicant corresponding to each marker.

The interview comment set includes: a plurality of interview types, an interview comment corresponding to each of the plurality of interview types and an identity marker of an interviewer making the interview comment.

The interviewer information set includes: a plurality of job types, a level corresponding to each of the plurality of job types and a type of an interviewer marked by each of the plurality of job types.

In the procedure of this embodiment, in order to reduce a data deviation, cleaning and pre-processing may be performed on the related interview data collected by the above acts, job levels of interviewers in the interviewer information set are determined; an identity marker of an interviewer subordinated by a level lower than a preset threshold is determined and taken as a target identity marker; and description information of an interview comment corresponding to the target identity marker is deleted from the interview comment set. By the above acts, the assisted interview model may be obtained by training recruitment interview records joined by experienced interviewers, such that the evaluation of the assisted interview model is more accurate, and the interview effect is improved from another dimensions.

Or, the data deviation may be reduced by executing acts, including but being not limited to the following.

1. Data filtering, that is, performing pre-filtering on the related interview data, in which, the detailed method includes but is not limited to: filtering out the recruitment interview record joined by the experienced interviewer; analyzing a job requirement, a resume and an interview comment text; extracting valid information and removing information (such as, the name and the contact information of the applicant) not related to the recruitment interview.

2. Data cleaning, that is, performing a further cleaning on the filtered interview data, in which, the detailed method includes but is not limited to word segmentation, stop word removal, meaningless high frequency and low frequency word removal.

3. Data representation, that is, unformatted interview data is represented as a format form that is easy to handle by the computer, in which, the detailed method includes but is not limited to a vector space model and a word bag model.

4. Data aggregation, that is, performing splicing processing on all the interview comments experienced by the same applicant in the interview data, and determining a tag (such as, a technical interview TI, a comprehensive interview CI) for each word in the interview comment based on the job level (such as, a technology interviewer, a comprehensive interviewer) of the interviewer, to form a matching pair (the resume and the interview comment), in which, the matching pair may be called as a preset matching pair. Finally, a job is taken as a unit to aggregate the matching pairs (the resumes and the interview comments) applying the same job, to form the aggregation.

At block S302, a fourth parameter distribution corresponding to the description information of each data in a first type of data set is determined, a fifth parameter distribution corresponding to the description information of each data in a second type of data set is determined, a sixth parameter distribution corresponding to the description information of each data in a third type of data set is determined, and a seventh parameter based on a fourth type of data set is determined.

The first type of data set is the job data set, in which, the job data set includes: the plurality of jobs and the description information of each of the plurality of jobs.

The second type of data set is the applicant data set, in which, the applicant data set includes: the plurality of markers and the description information of the applicant corresponding to each marker.

The third type of data set is the interview comment set, in which, the interview comment set includes: the plurality of interview types, the interview comment corresponding to each of the plurality of interview types and the identity marker of the interviewer making the interview comment.

The fourth type of data set is the interviewer information set, in which, the interviewer information set includes: the plurality of job types, the level corresponding to each of the plurality of job types and the type of the interviewer marked by each of the plurality of job types.

The fourth parameter distribution is configured to indicate a distribution of one or more keywords comprised in the description information of each data in the first type of data set, the fifth parameter distribution is configured to indicate a distribution of one or more keywords comprised in the description information of each data in the second type of data set, and the sixth parameter distribution is configured to indicate a distribution of one or more keywords comprised in the description information of each data in the third type of data set.

Based on the fourth type of data set, an interviewer job marker corresponding to the sixth parameter distribution may be obtained as a seventh parameter.

At block S303, a target model is trained according to the fourth parameter distribution, the fifth parameter distribution, the sixth parameter distribution and the seventh parameter, and the trained target model is taken as the assisted interview model.

Alternatively, the target model is a probability model in the artificial intelligence. The probability model is generated based on a joint perception learning technology in the artificial intelligence.

Referring to FIG. 4, FIG. 4 is a schematic diagram illustrating a target model according to embodiments of the present disclosure. The above fourth parameter distribution corresponds to w^{J} in FIG. 4, the above fifth parameter distribution corresponds to w^{R} in FIG. 4, the above sixth parameter distribution corresponds to w^{E} in FIG. 4, and the above seventh parameter corresponds to I in FIG. 4.

The probability model may be such as the Bayesian network model. The model may be configured to learn potential topics and corresponding relationships among the description information of the job, the description information of the resume and the interview comment in the recruitment interview.

As an example, it is assumed that the cleaned and pre-processed interview data has |M| jobs, and the m-th job Jₘ={wₘⱼ^{J}}ⱼ₌₁^{N}^{ₘ}^{^{J}} has Dₘ applicants to apply for, that is, the Dₘ preset matching pairs (resumes and interview comments) are Aₘ={(R_{md},E_{md})}_{d=1}^{D}^{ₘ}, in which, R_{md}={w_{mdr}^{R}}ᵣ₌₁^{N}^{ₘ}^{^{R}} is the description information of the resume, and E_{md}={w_{mde}^{E}}ₑ₌₁^{N}^{ₘ}^{^{E}} is the interview comment (w_{*}^{*} is a word representation).

In this embodiment, in order to train the probability model in the artificial intelligence, it may be assumed that the description information of the job has a topic set φ^{J}, the description information of the resume has a topic set φ^{R}, and the interview comment has a topic set φ^{E}.

In this embodiment, considering the interviewer, an interview flow is generally designed according to the resume of the applicant, thus it may be assumed that the same preset matching pair (R_{md}, E_{md}) (the resume and the interview comment) shares the same topic distribution θ_{md}^{A}. Next, the applicant usually writes the resume according to the actual recruitment needs of the job, and all the applicants with different experience may be suitable candidates for the same job. Therefore, based on the above features in the actual applying scene, there is a strong association relationship between the topic involved by the description information of the resume and the topic involved by the description information of the job. However, the topics involved by the description information of the resume and the description information of the job are diverse, and may have difference.

Therefore, in embodiments of the present disclosure, it may also be assumed that the topic distribution θ_{md}^{A} involved by the preset matching pair (the resume and the interview comment) is generated by the Gaussian distribution taking an extension vector h(θₘ^{J},C) of topic distribution θₘ^{J} involved by the description information of the job as the average value, in which, h(θₘ^{J},C) is obtained by c log θₘ^{J} vectors connecting end to end.

Based on the above assumed relationship, it may obtain that, the size relationship among the topic sets φ^{J}, φ^{R} and φ^{E} is |k^{R}|=|k^{E}|=C|k^{J}|=CK. Meanwhile, the topics φ^{ET} and φ^{EC} involved by the technology interview comment and the comprehensive interview comment are apparently different.

Therefore, in embodiments of the present disclosure, by the distribution of the keyword contained in the description information, the topic distribution φ^{E}∈{φ^{ET},φ^{EC}} involved by generating the keyword is selected according to the interview category tag of each keyword.

Further, as an example, following may be referred.

1. The keyword distributions φₖ^{J}˜Dir(β^{J}), φ_{k′}^{R}˜Dir(β^{R})m φ_{k′}^{ET}˜Dir(β^{E}), φ_{k′}^{EC}˜Dir(β^{E}) of the topic distributions involved by the description information of the job, the description information of the resume and the interview comments, may be generated in advance, in which, k=1, . . . , K, k′=1, . . . , CK.

2. For each job Jₘ, the involved topic distribution θₘ^{J}˜Dir(α) is generated by the Dirichlet distribution first. Then a topic subscript zₘⱼ^{J}˜Multi(βₘ^{J}) of each keyword in the description information of the job is generated by θₘ^{J}, and each keyword wₘⱼ^{J}˜Multi(φ_{z}_{ₘⱼ}_{^{J}}^{J}) is generated. After, for each preset matching pair (the resume and the interview comment) applying for the job, the involved topic distribution θ_{md}^{A}˜N(h(θₘ^{J},C),δ²I) is generated.

3. A topic subscript z_{mdr}^{R}˜Multi(π(θ_{md}^{A})) involved by each keyword in the resume is generated by θ_{md}^{A}, and each keyword w_{mdr}^{R}˜Multi(φ_{z}_{_{mdr}}_{^{R}}^{R}) in the resume is generated, in which, π(θ_{md}^{A}) is the logistic transformation

$$π ( {θ}_{md , k}^{A} ) = \frac{exp ( {θ}_{md , k}^{A} )}{{\sum }_{i = 1}^{CK} exp ( {θ}_{md , i}^{A} )} .$$

4. A topic subscript z_{mde}^{E}˜Multi(θ_{md}^{A}) involved by each keyword in the interview comment is generated by θ_{md}^{A}.

5. It needs to consider the influence of the interview category at the time of generating each keyword in the interview comment according to zₘ^{E}, that is, if I_{mde}=TI,

$${w}_{mde}^{E} \sim Multi ( {ϕ}_{{z}_{mde}^{E}}^{ET} ) ,$$

### and if I_{mde}=CI,

$${w}_{mde}^{E} \sim Multi ( {ϕ}_{{z}_{mde}^{E}}^{EC} ) .$$

With embodiments of the present disclosure, the following target model may be trained, the training target is configured to enable the output value of the target model maximum, and the target model enabling the output value of the target model maximum is the assisted interview model obtained by training in embodiments of the present disclosure. The target model is as follows:

$$p = {\sum }_{m = 1}^{\vert M \vert} p ( {θ}_{m}^{J} \vert α ) {\prod }_{j = 1}^{{N}_{m}^{J}} p ( {z}_{mj}^{J} \vert {θ}_{m}^{J} ) p ( {w}_{mj}^{J} \vert {ϕ}_{{z}_{mj}^{J}}^{J} ) {\prod }_{d = 1}^{{D}_{m}} p ( {θ}_{md}^{A} \vert {θ}_{m}^{J} , {δ}^{2} ) \times {\prod }_{r = 1}^{{N}_{md}^{R}} p ( {z}_{mdr}^{R} \vert {θ}_{md}^{A} ) p ( {w}_{mdr}^{R} \vert {ϕ}_{{z}_{mdr}^{R}}^{R} ) {\prod }_{e = 1}^{{N}_{md}^{E}} p ( {z}_{mde}^{E} \vert {θ}_{md}^{A} ) p ( {w}_{mde}^{E} \vert {ϕ}_{{z}_{mde}^{E}}^{ET} , {ϕ}_{{z}_{mde}^{E}}^{EC} , {I}_{mde} ) \times {\prod }_{k = 1}^{K} p ( {φ}_{k}^{J} \vert {β}^{J} ) {\prod }_{k = 1}^{CK} p ( {φ}_{k}^{R} \vert {β}^{R} ) p ( {φ}_{k}^{ET} , {φ}_{k}^{EC} \vert {β}^{E} ) .$$

In embodiments, by training the assisted interview model in advance, the assisted interview model is driven based on text data recorded during massive excellent interviews, and no longer limited to a single interviewer, which learns and inherits interview experience and field knowledge of massive excellent interviewers, and mines the valuable topics, effectively avoiding subjectivity and one-sidedness in the conventional interview, and enabling the assessment effect more objective. And, the more excellent interview record data configured to train the probability model in the artificial intelligence is recorded, the more diverse, the better the model effect. Therefore, by collecting the interview data from the talent think tank project database, with increasing of text data of interview records in the company, an assessment effect may further be effectively improved, and the sustainability of the model may be guaranteed.

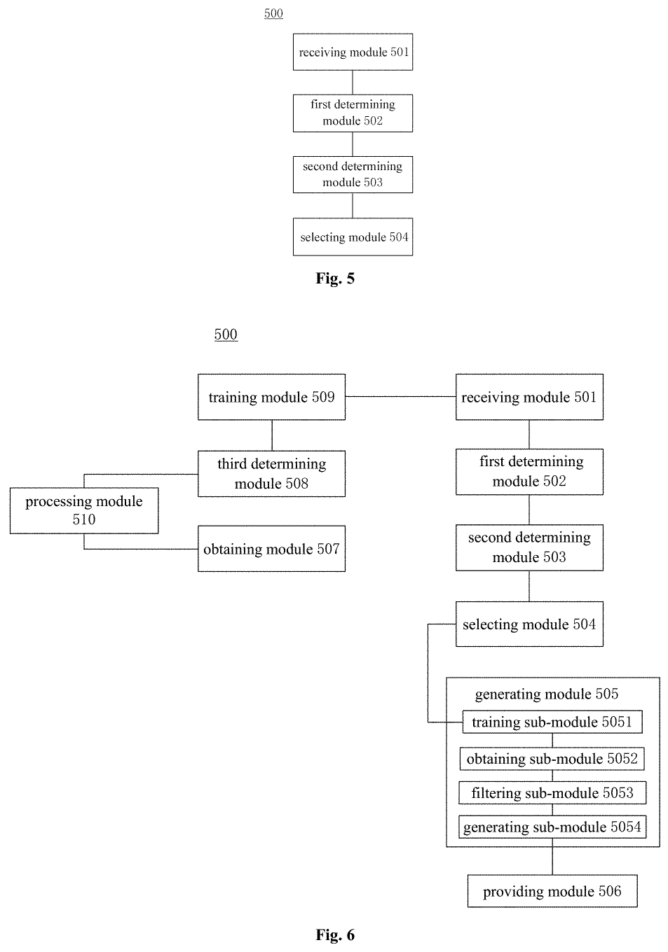

FIG. 5 is a block diagram illustrating a computer-assisted interview device based on artificial intelligence according to an embodiment of the present disclosure.

Referring to FIG. 5, the device 500 includes: a receiving module 501, a first determining module 502, a second determining module 503 and a selecting module 504.

The receiving module 501 is configured to receive description information of a job, and receive description information of each of a plurality of applicants.

The first determining module 502, is configured to, based on a pre-trained assisted interview model, determine a first parameter distribution corresponding to the description information of the job and determine a second parameter distribution corresponding to the description information of each of the plurality of applicants, in which, the first parameter distribution is configured to indicate a distribution of one or more topics referred by the description information of the job, and the second parameter distribution is configured to indicate a distribution of one or more topics referred by the description information of the corresponding applicant.

The second determining module 503 is configured to determine a matching degree between the job and each of the plurality of applicants based on the first parameter distribution and the second parameter distribution.

The selecting module 504 is configured to filter out an applicant corresponding to a matching degree meeting a first preset condition as a target applicant.

Alternatively, in some embodiments, referring to FIG. 6, the device 500 further includes: a generating module 505 and a providing module 506.

The generating module 505, is configured to, based on the second parameter distribution corresponding to the description information of the target applicant, in combination with a third parameter distribution of each of a plurality of questions in a preset question set, generate a recommendation question set corresponding to the target applicant, in which, the third parameter distribution is configured to indicate a distribution of one or more topics referred by each of the plurality of questions.

The providing module 506 is configured to provide the recommendation question set for an interviewer, to help the interviewer to interview the target applicant.

Alternatively, in some embodiments, referring to FIG. 6, the generating module 505 includes: a training sub-module 5051, an obtaining sub-module 5052, a filtering sub-module 5053 and a generating sub-module 5054.

The training sub-module 5051 is configured, based on the second parameter distribution corresponding to the description information of the target applicant, in combination with the third parameter distribution of each of the plurality of questions, to train a target function;

The obtaining sub-module 5052 is configured to obtain a training result corresponding to each target function;

The filtering sub-module 5053 is configured to filter out a question corresponding to a training result meeting a second preset condition.

The generating sub-module 5054 is configured to generate the recommendation set corresponding to the target applicant according to filtered questions.

Alternatively, in some embodiments, referring to FIG. 6, the device 500 further includes: an obtaining module 507, a third determining module 508 and a training module 509.

The obtaining module 507 is configured to obtain a plurality of types of data sets related to historic interview record, in which, each type of data set includes: a plurality of data and description information of each data.

The third determining module 508 is configured to determine a fourth parameter distribution corresponding to the description information of each data in a first type of data set, determine a fifth parameter distribution corresponding to the description information of each data in a second type of data set, determine a sixth parameter distribution corresponding to the description information of each data in a third type of data set, and determine a seventh parameter based on a fourth type of data set.

The training module 509 is configured to train a target model according to the fourth parameter distribution, the fifth parameter distribution, the sixth parameter distribution and the seventh parameter, and take the trained target model as the assisted interview model.

The fourth parameter distribution is configured to indicate a distribution of one or more keywords comprised in the description information of each data in the first type of data set, the fifth parameter distribution is configured to indicate a distribution of one or more keywords comprised in the description information of each data in the second type of data set, and the sixth parameter distribution is configured to indicate a distribution of one or more keywords comprised in the description information of each data in the third type of data set

Alternatively, in some embodiments, the plurality of types of data sets includes: a job data set, an applicant data set, an interview comment set and an interviewer information set.

The job data set includes: a plurality of jobs and description information of each of the plurality of jobs.

The applicant data set includes: a plurality of markers and description information of an applicant corresponding to each marker.

The interview comment set includes: a plurality of interview types, an interview comment corresponding to each of the plurality of interview types and an identity marker of an interviewer making the interview comment.

The interviewer information set includes: a plurality of job types, a level corresponding to each of the plurality of job types and a type of an interviewer marked by each of the plurality of job types.

Alternatively, in some embodiments, the target model is a probability model in the artificial intelligence.

Alternatively, in some embodiments, referring to FIG. 6, the device 500 further includes: a processing module 510, configured to determine job levels of interviewers in the interviewer information set; determine an identity marker of an interviewer subordinated by a level lower than a preset threshold and take the identity marker as a target identity marker; and delete description information of an interview comment corresponding to the target identity marker from the interview comment set.

It should be noted that, the explanation for the computer-assisted interview method based on artificial intelligence in the above FIG. 1-FIG. 4 embodiments is also applicable to the computer-assisted interview device 500 based on artificial intelligence, and the implementation principles are similar, which is not elaborated.

The above division for respective modules in the computer-assisted interview device 500 based on artificial intelligence is merely used for exemplary purposes. In other embodiments, the computer-assisted interview device 500 based on artificial intelligence may be divided into different modules based on needs, to finish all or part functions of the computer-assisted interview device based on artificial intelligence.

In embodiments, the applicant is filtered out as the target applicant to assist the interview according to the matching degree between the job and each of the plurality of applicants, and the matching degree is obtained based on the pre-trained assisted interview model. Therefore, it may assist the interviewer to interview in conjunction with artificial intelligent technologies, thereby providing a support of objective data, and improving the interview effect.

To achieve the above embodiments, the present disclosure further provides a non-temporary computer readable storage medium. When instructions in the storage medium are executed by a processor of a terminal, the terminal is caused to execute the computer-assisted interview method based on artificial intelligence. The method includes:

receiving description information of a job;

receiving description information of each of a plurality of applicants;

based on a pre-trained assisted interview model, determining a first parameter distribution corresponding to the description information of the job and determining a second parameter distribution corresponding to the description information of each of the plurality of applicants, in which, the first parameter distribution is configured to indicate a distribution of one or more topics referred by the description information of the job, and the second parameter distribution is configured to indicate a distribution of one or more topics referred by the description information of the corresponding applicant;

determining a matching degree between the job and each of the plurality of applicant based on the first parameter distribution and the second parameter distribution; and

filtering out an applicant corresponding to a matching degree meeting a first preset condition as a target applicant.

With the non-temporary computer readable storage medium provided by embodiments, the applicant is filtered out as the target applicant to assist the interview according to the matching degree between the job and each of the plurality of applicants, and the matching degree is obtained based on the pre-trained assisted interview model. Therefore, it may assist the interviewer to interview in conjunction with artificial intelligent technologies, thereby providing a support of objective data, and improving the interview effect.

To achieve the above embodiments, the present disclosure further provides a computer program product. When instructions in the computer program product are executed by a processor, the computer-assisted interview method based on artificial intelligence is executed. The method includes:

receiving description information of a job;

receiving description information of each of a plurality of applicants;

based on a pre-trained assisted interview model, determining a first parameter distribution corresponding to the description information of the job and determining a second parameter distribution corresponding to the description information of each of the plurality of applicants, in which, the first parameter distribution is configured to indicate a distribution of one or more topics referred by the description information of the job, and the second parameter distribution is configured to indicate a distribution of one or more topics referred by the description information of the corresponding applicant;

determining a matching degree between the job and of the plurality of applicant based on the first parameter distribution and the second parameter distribution; and

filtering out an applicant corresponding to a matching degree meeting a first preset condition as a target applicant.

With the computer program product in embodiments, the applicant is filtered out as the target applicant to assist the interview according to the matching degree between the job and each of the plurality of applicants, and the matching degree is obtained based on the pre-trained assisted interview model. Therefore, it may assist the interviewer to interview in conjunction with artificial intelligent technologies, thereby providing a support of objective data, and improving the interview effect.

It should be illustrated that, in description of the present disclosure, the terms “first”, “second” are only for description purpose, and it cannot be understood as indicating or implying its relative importance. In addition, in the description of the present disclosure, unless otherwise indicated, “a plurality of” means at least two.

Any procedure or method described in the flow charts or described in any other way herein may be understood include one or more modules, portions or parts for executing instruction codes that implement steps of a custom logic function or procedure. And preferable embodiments of the present disclosure include other implementation, in which the order of execution is different from that which is depicted or discussed, including executing functions in a substantially simultaneous manner or in an opposite order according to the related functions, which may be understood by the skilled in the art of embodiments of the present disclosure.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The above-mentioned storage medium may be a ROM (read-only memory), a magnetic disk or a disk and the like.

In the description of the present disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although embodiments of the present disclosure have been shown and described above, it should be understood that, the above embodiments are exemplary, and are not understood to limit the present disclosure. Those skilled in the art can make changes, modifications, alternatives and variants in the above embodiments within scope of the present disclosure.

What is claimed is:

1. A computer-assisted interview method based on artificial intelligence, comprising:
receiving, by one or more computing devices, description information of a job;
receiving, by the one or more computing devices, description information of each of a plurality of applicants;
based on a pre-trained assisted interview model, determining, by the one or more computing devices, a first parameter distribution corresponding to the description information of the job and determining, by the one or more computing devices, a second parameter distribution corresponding to the description information of each of the plurality of applicants, wherein the first parameter distribution is configured to indicate a distribution of one or more topics referred by the description information of the job, and the second parameter distribution is configured to indicate a distribution of one or more topics referred by the description information of the corresponding applicant;
determining, by the one or more computing devices, a matching degree between the job and each of the plurality of applicants based on the first parameter distribution and the second parameter distribution; and
filtering out, by the one or more computing devices, an applicant corresponding to a matching degree meeting a first preset condition as a target applicant.

2. The method of claim 1, further comprising:
based on the second parameter distribution corresponding to the description information of the target applicant, in combination with a third parameter distribution of each of a plurality of questions in a preset question set, generating, by the one or more computing devices, a recommendation question set corresponding to the target applicant, wherein, the third parameter distribution is configured to indicate a distribution of one or more topics referred by each of the plurality of questions; and
providing, by the one or more computing devices, the recommendation question set for an interviewer, to help the interviewer to interview the target applicant.

3. The method of claim 2, wherein, based on the second parameter distribution corresponding to the description information of the target applicant, in combination with the third parameter distribution of each of the plurality of questions in the preset question set, generating the recommendation question set corresponding to the target applicant, comprises:
based on the second parameter distribution corresponding to the description information of the target applicant, in combination with the third parameter distribution of each of the plurality of questions, training, by the one or more computing devices, a target function;
obtaining, by the one or more computing devices, a training result corresponding to each target function;
filtering out, by the one or more computing devices, a question corresponding to a training result meeting a second preset condition; and
generating, by the one or more computing devices, the recommendation set corresponding to the target applicant according to filtered questions.

4. The method of claim 1, further comprising:
obtaining, by the one or more computing devices, a plurality of types of data sets related to historic interview record, wherein, each type of data set comprises: a plurality of data and description information of each data;
determining, by the one or more computing devices, a fourth parameter distribution corresponding to the description information of each data in a first type of data set, determining, by the one or more computing devices, a fifth parameter distribution corresponding to the description information of each data in a second type of data set, determining, by the one or more computing devices, a sixth parameter distribution corresponding to the description information of each data in a third type of data set, and determining, by the one or more computing devices, a seventh parameter based on a fourth type of data set; and
training, by the one or more computing devices, a target model according to the fourth parameter distribution, the fifth parameter distribution, the sixth parameter distribution and the seventh parameter, and taking the trained target model as the assisted interview model;
wherein, the fourth parameter distribution is configured to indicate a distribution of one or more keywords comprised in the description information of each data in the first type of data set, the fifth parameter distribution is configured to indicate a distribution of one or more keywords comprised in the description information of each data in the second type of data set, and the sixth parameter distribution is configured to indicate a distribution of one or more keywords comprised in the description information of each data in the third type of data set.

5. The method of claim 4, wherein, the plurality of types of data sets comprises:
a job data set, in which, the job data set comprises: a plurality of jobs and description information of each of the plurality of jobs;
an applicant data set, in which, the applicant data set comprises: a plurality of markers and description information of an applicant corresponding to each marker;
an interview comment set, in which, the interview comment set comprises: a plurality of interview types, an interview comment corresponding to each of the plurality of interview types and an identity marker of an interviewer making the interview comment; and
an interviewer information set, in which, the interviewer information set comprises: a plurality of job types, a level corresponding to each of the plurality of job types and a type of an interviewer marked by each of the plurality of job types.

6. The method of claim 4, wherein, the target model is a probability model in the artificial intelligence.

7. The method of claim 4, further comprising:
determining, by the one or more computing devices, job levels of interviewers in the interviewer information set;
determining, by the one or more computing devices, an identity marker of an interviewer subordinated by a level lower than a preset threshold and taking the identity marker as a target identity marker; and
deleting, by the one or more computing devices, description information of an interview comment corresponding to the target identity marker from the interview comment set.

8. An electronic device, comprising:
one or more processors;
a memory;
one or more programs, stored in the memory, when being executed by the one or more processors, configured to perform the following acts:
receiving description information of a job;
receiving description information of each of a plurality of applicants;
based on a pre-trained assisted interview model, determining a first parameter distribution corresponding to the description information of the job and determining a second parameter distribution corresponding to the description information of each of the plurality of applicants, wherein the first parameter distribution is configured to indicate a distribution of one or more topics referred by the description information of the job, and the second parameter distribution is configured to indicate a distribution of one or more topics referred by the description information of the corresponding applicant;
determining a matching degree between the job and each of the plurality of applicants based on the first parameter distribution and the second parameter distribution; and
filtering out an applicant corresponding to a matching degree meeting a first preset condition as a target applicant.

9. The electronic device of claim 8, wherein the acts further comprise:
based on the second parameter distribution corresponding to the description information of the target applicant, in combination with a third parameter distribution of each of a plurality of questions in a preset question set, generating a recommendation question set corresponding to the target applicant, wherein, the third parameter distribution is configured to indicate a distribution of one or more topics referred by each of the plurality of questions; and
providing the recommendation question set for an interviewer, to help the interviewer to interview the target applicant.

10. The electronic device of claim 9, wherein, based on the second parameter distribution corresponding to the description information of the target applicant, in combination with the third parameter distribution of each of the plurality of questions in the preset question set, generating the recommendation question set corresponding to the target applicant, comprises:
based on the second parameter distribution corresponding to the description information of the target applicant, in combination with the third parameter distribution of each of the plurality of questions, training a target function;
obtaining a training result corresponding to each target function;
filtering out a question corresponding to a training result meeting a second preset condition; and
generating the recommendation set corresponding to the target applicant according to filtered questions.

11. The electronic device of claim 8, wherein the acts further comprise:
obtaining a plurality of types of data sets related to historic interview record, wherein, each type of data set comprises: a plurality of data and description information of each data;
determining a fourth parameter distribution corresponding to the description information of each data in a first type of data set, determining a fifth parameter distribution corresponding to the description information of each data in a second type of data set, determining a sixth parameter distribution corresponding to the description information of each data in a third type of data set, and determining a seventh parameter based on a fourth type of data set; and
training a target model according to the fourth parameter distribution, the fifth parameter distribution, the sixth parameter distribution and the seventh parameter, and taking the trained target model as the assisted interview model;
wherein, the fourth parameter distribution is configured to indicate a distribution of one or more keywords comprised in the description information of each data in the first type of data set, the fifth parameter distribution is configured to indicate a distribution of one or more keywords comprised in the description information of each data in the second type of data set, and the sixth parameter distribution is configured to indicate a distribution of one or more keywords comprised in the description information of each data in the third type of data set.

12. The electronic device of claim 11, wherein, the plurality of types of data sets comprises:
a job data set, in which, the job data set comprises: a plurality of jobs and description information of each of the plurality of jobs;
an applicant data set, in which, the applicant data set comprises: a plurality of markers and description information of an applicant corresponding to each marker;
an interview comment set, in which, the interview comment set comprises: a plurality of interview types, an interview comment corresponding to each of the plurality of interview types and an identity marker of an interviewer making the interview comment; and
an interviewer information set, in which, the interviewer information set comprises: a plurality of job types, a level corresponding to each of the plurality of job types and a type of an interviewer marked by each of the plurality of job types.

13. The electronic device of claim 11, wherein, the target model is a probability model in the artificial intelligence.

14. The electronic device of claim 11, wherein the acts further comprise:
determining job levels of interviewers in the interviewer information set;
determining an identity marker of an interviewer subordinated by a level lower than a preset threshold and taking the identity marker as a target identity marker; and
deleting description information of an interview comment corresponding to the target identity marker from the interview comment set.

15. A non-temporary computer readable storage medium having stored one or more programs thereon, wherein, when the one or more programs are executed by a processor, a computer-assisted interview method based on artificial intelligence is implemented, the method including:
receiving description information of a job;
receiving description information of each of a plurality of applicants;
based on a pre-trained assisted interview model, determining a first parameter distribution corresponding to the description information of the job and determining a second parameter distribution corresponding to the description information of each of the plurality of applicants, wherein the first parameter distribution is configured to indicate a distribution of one or more topics referred by the description information of the job, and the second parameter distribution is configured to indicate a distribution of one or more topics referred by the description information of the corresponding applicant;
determining a matching degree between the job and each of the plurality of applicants based on the first parameter distribution and the second parameter distribution; and
filtering out an applicant corresponding to a matching degree meeting a first preset condition as a target applicant.

16. The non-temporary computer readable storage medium of claim 15, wherein the method further comprises:
based on the second parameter distribution corresponding to the description information of the target applicant, in combination with a third parameter distribution of each of a plurality of questions in a preset question set, generating a recommendation question set corresponding to the target applicant, wherein, the third parameter distribution is configured to indicate a distribution of one or more topics referred by each of the plurality of questions; and
providing the recommendation question set for an interviewer, to help the interviewer to interview the target applicant.

17. The non-temporary computer readable storage medium of claim 16, wherein, based on the second parameter distribution corresponding to the description information of the target applicant, in combination with the third parameter distribution of each of the plurality of questions in the preset question set, generating the recommendation question set corresponding to the target applicant, comprises:
based on the second parameter distribution corresponding to the description information of the target applicant, in combination with the third parameter distribution of each of the plurality of questions, training a target function;
obtaining a training result corresponding to each target function;
filtering out a question corresponding to a training result meeting a second preset condition; and
generating the recommendation set corresponding to the target applicant according to filtered questions.

18. The non-temporary computer readable storage medium of claim 15, wherein the method further comprises:
obtaining a plurality of types of data sets related to historic interview record, wherein, each type of data set comprises: a plurality of data and description information of each data;
determining a fourth parameter distribution corresponding to the description information of each data in a first type of data set, determining a fifth parameter distribution corresponding to the description information of each data in a second type of data set, determining a sixth parameter distribution corresponding to the description information of each data in a third type of data set, and determining a seventh parameter based on a fourth type of data set; and
training a target model according to the fourth parameter distribution, the fifth parameter distribution, the sixth parameter distribution and the seventh parameter, and taking the trained target model as the assisted interview model;
wherein, the fourth parameter distribution is configured to indicate a distribution of one or more keywords comprised in the description information of each data in the first type of data set, the fifth parameter distribution is configured to indicate a distribution of one or more keywords comprised in the description information of each data in the second type of data set, and the sixth parameter distribution is configured to indicate a distribution of one or more keywords comprised in the description information of each data in the third type of data set.

19. The non-temporary computer readable storage medium of claim 18, wherein, the target model is a probability model in the artificial intelligence.

20. The non-temporary computer readable storage medium of claim 18, wherein the method further comprises:
determining job levels of interviewers in the interviewer information set;
determining an identity marker of an interviewer subordinated by a level lower than a preset threshold and taking the identity marker as a target identity marker; and
deleting description information of an interview comment corresponding to the target identity marker from the interview comment set.
